(19) United States
(12) Patent Application Publication
(10) Pub. No.: US 2018/0237314 A1
(43) Pub. Date: Aug. 23, 2018

(54) SYNTHESIS OF DEEP EUTECTIC SOLVENT CHEMICAL PRECURSORS AND THEIR USE IN THE PRODUCTION OF METAL OXIDES

(71) Applicant: YANGCHUAN XING, COLUMBIA, MO (US)

(72) Inventor: YANGCHUAN XING, COLUMBIA, MO (US)

(21) Appl. No.: 15/751,000

(22) PCT Filed: Aug. 8, 2016
(86) PCT No.: PCT/US2016/045963

§ 371 Date: Feb. 7, 2018

Related U.S. Application Data
(60) Provisional application No. 62/347,925, filed on Jun. 9, 2016.
(60) Provisional application No. 62/202,243, filed on Aug. 7, 2015.

(51) Int. Cl. C01G 53/00; B01J 19/12; H01M 10/0525; H01M 4/525; H01M 4/505

(52) U.S. Cl. CPC C01G 53/50; B01J 19/126; H01M 10/0525; H01M 2004/028; H01M 4/505; B01J 2219/0877; B01J 2219/1206; H01M 4/525

(57) ABSTRACT

The present invention is directed in a first aspect to a process for forming a deep eutectic solvent chemical precursor. The process includes the steps of providing one or more metal ion donors, preferably one or more salts; providing one or more hydrogen bond donors, and combining the one or more salts with the one or more hydrogen bond donors. The present invention is directed in a second aspect to forming one or more metal oxides by reacting one or more of the deep eutectic solvents of the first aspect of the invention through the application of heat via methods such as flame spray pyrolysis or the application of microwaves.

### CROSS-REFERENCE TO RELATED APPLICATIONS

This application is based on and claims priority to U.S. Provisional Application Ser. No. 62/202,243 filed on Aug. 7, 2015 and U.S. Provisional Application Ser. No. 62/347,925 filed on Jun. 9, 2016, which are hereby incorporated herein by reference.

### BACKGROUND OF THE INVENTION

### 1. Field of the Invention

The present invention is directed to the field of chemical precursors used in the production of metal oxides, and more specifically directed to a process for forming deep eutectic solvent (DES) chemical precursors containing metal ions and a process for using said DES chemical precursors in the production of metal oxides.

### 2. Description of Related Art

Metal oxide powders are used in a variety of technologies including but not limited to batteries, in particular lithium-ion batteries. Exemplary lithium-ion batteries use lithium nickel cobalt aluminum oxide (NCA) and lithium nickel manganese cobalt oxide (NMC) as cathode active materials. Known processes for making metal oxide powders for use in the manufacture of batteries typically use either gaseous or aqueous precursors.

Known gaseous precursors can be burned or reacted to form metal oxide powders. Known gaseous precursors that can be gasified or that have high enough vapor pressures, however, are limited due to the metals involved, many of which either cannot form a gaseous precursor or are prohibitively expensive to produce.

Known aqueous precursors use solvents that are either water or a combination of water and low alcohols such as ethanol or methanol. Known aqueous precursors are generally expensive given that their purity must be high in order to produce metal oxides that are likewise of sufficiently high purity, and the metal hydroxides require additional washing. Following the production process, the wastewater has to be treated, which adds additional cost.

Lithium-ion batteries use metal oxides in powder form for their cathode materials. Exemplary metal oxides used for this purpose include LiCoO₂, LiMn₂O₄, Li(Ni_{1/3}Mn_{1/3}Co_{1/3})O₂, and Li(Ni_{0.8}Co_{0.15}Al_{0.05})O₂. The commercial processes for producing these materials use metal salts, such as nitrates or sulfates dissolved in water. The pH of the solution is adjusted in order to precipitate out metal hydroxides. The metal hydroxides are further processed in a high temperature annealing process to form metal oxides, and this processing is energy intensive.

One non-commercialized alternative to the commercial processes currently used to make metal oxide powders is the use of aqueous salt solutions in spray pyrolysis with or without a flame. The spray temperature in the nozzle cannot be too far over the boiling point of the solvent in order to avoid salt precipitation in the spraying equipment, which can cause clogging. Furthermore, the solubility of the salts used to form the aqueous precursors is often limited, which results in the use of a large volume of the solvent. This reduces the production rate of the metal oxides and increases the cost associated with water purification and wastewater treatment.

### BRIEF SUMMARY OF THE INVENTION

In a first aspect, the present invention is directed to a process for forming a deep eutectic solvent chemical precursor containing one or more metal ions. The process includes the steps of: providing one or more metal ion donors, preferably one or more salts; providing one or more hydrogen bond donors; and combining the one or more salts with the one or more hydrogen bond donors.

In one embodiment of the first aspect of the present invention, each of the one or more salts is selected from the group consisting of hydrated metal acetates, hydrated metal oxalates, hydrated metal nitrates, hydrated metal sulfates, hydrated metal halides, metal acetates, metal oxalates, metal nitrates, metal sulfates, metal halides, metal alkoxides, and combinations thereof. Preferably, each of the one or more salts is selected from the group consisting of lithium acetate (Li(CH₃COO)), manganese acetate (Mn(CH₃COO)₂); cobalt acetate (Co(CH₃COO)₂); nickel acetate (Ni(CH₃COO)₂); Li(Ni_{1/3}Mn_{1/3}Co_{1/3})(CH₃COO)₃; Li(CH₃COO).2H₂O; Mn(CH₃COO)₂.4H₂O; Co(CH₃COO)₂.4H₂O; Ni(CH₃COO)₂.4H₂O; LiCl; MnCl₂; CoCl₂; NiCl₂; AlCl₃; LiClH₂O; MnCl₂.6H₂O; CoCl₂.6H₂O; NiCl₂.6H₂O; AlCl₃.9H₂O; Ni(NO₃)₂, Mn(NO₃)₂; Co(NO₃)₂; LiNO₃; Zn(NO₃)₂; Mn(NO₃)₂.4H₂O; Co(NO₃)₂.4H₂O; LiNO₃.xH₂O (x=0.5-3); Al(NO₃)₃.9H₂O; and combinations thereof.

In another embodiment of the first aspect of the present invention, each of the one or more hydrogen bond donors is selected from the group consisting of glycerol, ethylene glycol, acetamide, urea, and combinations thereof. More preferably, the one or more hydrogen bond donors is glycerol. In the preferred embodiment of the first aspect of the present invention using glycerol as the hydrogen bond donor, the molar ratio of the salt to glycerol is between 1:1 and 1:10. More preferably, the molar ratio of the salt to glycerol is between 1:4 and 1:6. Most preferably, the molar ratio of the salt to the glycerol is 1:5.

In still another embodiment of the first aspect of the present invention, prior to the combining step, the one or more hydrogen bond donors are heated to reduce their viscosity. More preferably, the one or more hydrogen bond donors are heated to reduce their viscosity by an order of magnitude. Preferably, the combining step is carried out by constantly stirring the one or more hydrogen bond donors and gradually adding the one or more salts to the one or more hydrogen bond donors. Preferably, following the combining step, the combination of the one or more salts and the one or more hydrogen bond donors are heated to reduce the viscosity of the combination of the one or more salts and the one or more hydrogen bond donors. More preferably, the combination of the one or more salts and the one or more hydrogen bond donors are heated to reduce the viscosity of the combination of the one or more salts and the one or more hydrogen bond donors, preferably by an order of magnitude. In certain embodiments where the one or more hydrogen bond donors is glycerol, the combination is heated to a temperature of 100 degrees Celsius for a time period of two hours.

In one more embodiment of the first aspect of the present invention, the salt is a metal acetate formed by providing a metal carbonate, providing acetic acid, and reacting the metal carbonate with the acetic acid.

In a second aspect, the present invention is directed to a process for forming one or more metal oxides. The process includes the steps of: providing one or more deep eutectic solvents of the first aspect of the present invention; and reacting the one or more deep eutectic solvents to produce one or more metal oxides.

In one embodiment of the second aspect of the present invention, the reaction step is flame spray pyrolysis to produce the one or more metal oxides. Preferably, the flame spray pyrolysis is carried out at a temperature between 500 and 2000 degrees Celsius.

In another embodiment of the second aspect of the present invention, the reaction step is microwaving the deep eutectic solvent to produce one or more metal oxides.

In yet another embodiment of the second aspect of the present invention, one or more deep eutectic solvents are provided during the providing step to produce at least one metal oxide that includes at least two different metals.

In still another embodiment of the second aspect of the present invention, the metal oxides are in powder form. Preferably, the metal oxides are suitable for use in lithium-ion batteries.

In an embodiment of the second aspect of the present invention, at least one of the metal oxides is selected from the group consisting of LiCoO₂, LiMn₂O₄, Li₁(NiMnCo)_{0.33}O₂, Li(Ni_{0.8}Co_{0.15}Al_{0.05})O₂, and combinations thereof.

In yet another embodiment of the second aspect of the present invention, at least one of the metal oxides is selected from the group consisting of lithium oxide, cobalt oxide, manganese oxide, nickel oxide, and combinations thereof.

In yet another embodiment of the second aspect of the present invention, the reacting step further includes the production of carbon dioxide and water.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a photograph of various deep eutectic solvent (DES) chemical precursors in accordance with a first aspect of the present invention.

FIG. 2 is a photograph of various DES chemical precursors prepared in accordance with a first aspect of the present invention.

FIG. 3 is an electron microscopy image of a NMC oxide (Li(Ni_{1/3}Mn_{1/3}Co_{1/3})O₂) powder prepared in a flame spray pyrolysis process in accordance with a second aspect of the present invention.

FIG. 4 is an electron microscopy image of a NMC oxide (Li(Ni_{1/3}Mn_{1/3}Co_{1/3})O₂) powder prepared in a microwave process in accordance with a second aspect of the present invention.

### DETAILED DESCRIPTION OF PREFERRED EMBODIMENT

In a first aspect, the present invention is directed to a process for forming a deep eutectic solvent (DES) chemical precursor containing one or more metal ions. The process includes the steps of 1) providing one or more salts, 2) providing one or more hydrogen bond donors, and 3) combining the one or more salts with the one or more hydrogen bond donors.

The individual components of the DES chemical precursor and their relative concentrations will now be described. Suitable salts include, but are not limited to, hydrated metal acetates, hydrated metal oxalates, hydrated metal nitrates, hydrated metal sulfates, hydrated metal halides, metal acetates, metal oxalates, metal nitrates, metal sulfates, metal halides, metal alkoxides, and combinations thereof. Suitable metal acetates include, but are not limited to, lithium acetate (Li(CH₃COO)), manganese acetate (Mn(CH₃COO)₂); cobalt acetate (Co(CH₃COO)₂); nickel acetate (Ni(CH₃COO)₂); and combinations thereof. Suitable hydrated metal acetates include, but are not limited to, Li(CH₃COO)₂H₂O; Mn(CH₃COO)₂.4H₂O; Co(CH₃COO)₂.4H₂O; Ni(CH₃COO)₂.4H₂O; and combinations thereof. Hydrated metal acetates are more preferable than metal acetates. Suitable metal halides include, but are not limited to LiCl, MnCl₂, CoCl₂, NiCl₂, and AlCl₃. Suitable hydrated metal halides include, but are not limited to, LiClH₂O, MnCl₂.6H₂O, CoCl₂.6H₂O, NiCl₂.6H₂O, AlCl₃.9H₂O. Suitable metal nitrates include, but are not limited to: Ni(NO₃)₂; Mn(NO₃)₂; Co(NO₃)₂; LiNO₃; and Al(NO₃)₃. Suitable hydrated metal nitrates include, but are not limited to: Ni(NO₃)₂.4H₂O; Mn(NO₃)₂.4H₂O; Co(NO₃)₂.4H₂O; LiNO₃.xH₂O (x=0.5-3) and Al(NO₃)₃.9H₂O.

The one or more hydrogen bond donors serve as complexing agents and are preferably alcohols with three or more carbons. Preferably, the one or more hydrogen bond donors/complexing agents are glycerol and ethylene glycol, acetamide, urea, and combinations thereof. More preferably, the one or more hydrogen bond donors is glycerol.

The thickness of the DES chemical precursor increases as the molar ratio of the one or more salts to the one or more hydrogen bond donors in the DES chemical precursor increases, and the thickness desired of the DES chemical precursor will depend on the application. Where the one or more hydrogen bond donors is glycerol, the molar ratio of the salt to the glycerol in the DES chemical precursor is preferably between 1:1 and 1:10, more preferably between 1:4 and 1:6, and most preferably is 1:5.

The process for preparing the DES chemical precursor will now be described in more detail. First, the one or more salts and the one or more hydrogen bond donors/complexing agents to be used are each measured out to pre-determined amounts that will meet the desired molar ratio of the components of the DES chemical precursor. Second, prior to combining the one or more salts and the one or more hydrogen bond donors of the DES chemical precursor, the one or more hydrogen bond donors are preferably heated to reduce the viscosity of the one or more hydrogen bond donors, preferably by an order of magnitude. Preferably, the one or more salts are gradually introduced into the one or more hydrogen bond donors as the one or more hydrogen bond donors are constantly stirred. After the one or more salts and the one or more hydrogen bond donors are combined, they are heated to reduce the viscosity of the DES chemical precursor, preferably by an order of magnitude.

Where the one or more hydrogen bond donors is glycerol, at low temperatures, for example at room temperature, the DES chemical precursor formation takes much longer, and due to the high viscosity of the combination of the salt and the glycerol, it is hard to mix. At too high of a temperature (greater than 150 degrees Celsius), metal glycerolate can form and precipitate out. In one preferred embodiment, the combination of the one or more salts and the glycerol are heated to a temperature of 100 degrees Celsius for a period of approximately two hours.

Some salts may not form a DES chemical precursor with one or more hydrogen bond donors without the addition of a third chemical or without first converting the salts to new salts. For example, certain metal carbonates cannot form DES chemical precursors. Specific non-limiting examples include, but are not limited to lithium carbonate. Unlike potassium carbonate, lithium carbonate must first be mixed with acetic acid to convert it to lithium acetate, then mixing the lithium acetate with one or more hydrogen bond donors such as glycerol to form a DES chemical precursor.

In a second aspect, the present invention is directed to a process for forming one or more metal oxides. Suitable metal oxides include, but are not limited to: lithium oxide, cobalt oxide, manganese oxide, nickel oxide, LiCoO₂, LiMn₂O₄, Li₁(NiMnCo)_{0.33}O₂, Li(Ni_{0.8}Co_{0.15}Al_{0.05})O₂, and combinations thereof. The process includes the steps of 1) providing one or more deep eutectic solvents of the first aspect of the invention, and 2) reacting the one or more deep eutectic solvent to produce one or more metal oxides. In certain embodiments, carbon dioxide and water are also produced. Generally speaking, the resulting metal oxides are in powder form, in certain aspects nanopowders, and certain metal oxides will be suitable for use in lithium-ion batteries.

In one embodiment, the reaction step is carried out through flame spray pyrolysis. First, the DES chemical precursor is heated to reduce its viscosity, preferably by an order of magnitude. In one embodiment, the DES chemical precursor is heated to a temperature ranging between 50 and 200 degrees Celsius. In one embodiment, the temperature is 100 degrees Celsius. Second, the DES chemical precursor is sprayed into the reaction chamber. In one embodiment, the flow rate of the DES chemical precursor ranges between 0.1 and 10 gph. The flow rate will depend on the DES chemical precursor used and the size of the spray nozzle. In one embodiment, the temperature of the flame spray reactor ranges between 500 and 2000 degrees Celsius. Preferably, where glycerol is the hydrogen bond donor/complexing agent, the temperature ranges from 800 to 1200 degrees Celsius. Third, after pyrolysis is complete, the metal oxide powders produced are collected downstream.

While flame spray pyrolysis is preferred, other spray pyrolysis processes can be also be used to obtain metal oxide powders. For example, a high temperature electric furnace can be used to pyrolyze the DES chemical precursors.

In one embodiment, microwaves are used to heat the precursors to make metal oxide powders. First, the DES chemical precursor is placed in a container, which is then placed in a microwave device. Second, the DES chemical precursor is heated. In one embodiment, the DES chemical precursor is heated for a time ranging from 2 to 30 min at a power ranging between 400 and 800 W to form metal oxide powder.

Alternatively, other heating mechanisms can be used.

It should be understood that the process of the second aspect of the invention can be carried out with a DES chemical precursor that includes two or more salts or with two or more DES chemical precursors to produce one or more metal oxides, carbon dioxide, and water. For example:

Li(CH₃COO)+Mn(CH₃COO)+O₂ yields LiMnO₂+CO₂+H₂O

Li(CH₃COO)+Co(CH₃COO)+O₂ yields LiCoO₂+CO₂+H₂O

The use of organic biomass byproducts as hydrogen bond donors causes the processes of the instant invention to be green chemical processes (known processes are not green). For example, glycerol is a biomass byproduct of biodiesel processing in the transesterification of triglycerides. In 2014, the global biodiesel production was approximately 7.45 billion gallons, which yielded 740 million gallons of crude glycerol. The use of glycerol in the processes of the instant invention will create a new market for the surplus of available glycerol and reduce the overall production cost of metal oxides.

### EXAMPLES

In Examples 1 and 2, described in more detail below, various DES chemical precursors were formed. The preparation of each DES chemical precursor was carried out according to the following steps. First, a pre-determined amount of each of the salts was measured out by weight. Second, a pre-determined amount of the hydrogen bond donor/complexing agent was weighed or measured by volume. In all of the examples, glycerol was used as the hydrogen bond donor/complexing agent. The amounts of the salts and glycerol used were dependent on the desired molar ratio of the salt to the hydrogen bond donor/complexing agent in each DES chemical precursor. Third, the glycerol was placed in a beaker and heated on a heating plate to about 50 degrees Celsius in order to reduce its viscosity by one order of magnitude (from approximately 1400 centipoise (cP) to approximately 140 centipoise (cP). The viscosity was reduced in order to facilitate the mixing of the salts with the glycerol. Fourth, the salts were added gradually to the glycerol in the beaker, under constant stirring with a magnetic stirrer. Fifth, after all of the salt was added to the glycerol in each beaker, the resulting mixture was placed on a heating plate and heated to 100 degrees Celsius in order to reduce the viscosity by approximately another order of magnitude for approximately two hours. Finally, the mixture was taken off of the heating plate and allowed to cool to room temperature. Each DES chemical precursor was a transparent liquid that is capable of remaining in solution for months.

In Examples 3 and 4, lithium nickel, manganese, and cobalt (NMC) oxide (Li(Ni_{1/3}Mn_{1/3}Co_{1/3})O₂) powders in accordance with the second aspect of the present invention were prepared from the DES chemical precursors prepared in Example 1 from hydrated metal acetates of the corresponding metals and glycerol.

### Example 1: Formation of Deep Eutectic Solvents (DES) Chemical Precursors with Hydrated Metal Acetates

DES chemical precursors were prepared using the following hydrated metal acetates: Li(CH₃COO).2H₂O; Mn(CH₃COO)₂.4H₂O; Co(CH₃COO)₂.4H₂O; Ni(CH₃COO)₂.4H₂O; and their combinations. Glycerol was used as the hydrogen bond donor/complexing agent and solvent. The DES chemical precursors are shown in FIG. 1. The molar ratio of the salts to the hydrogen bond donor/complexing agents for each of the samples was 1:5. These DES chemical precursors were all fairly thick liquids at room temperature. When heated to over 100° C., they were quite fluid. At this molar ratio, the salt loading of the DES chemical precursor shown at the right that used combinations of the hydrated metal acetates was approximately 43.16 (w/w) %, which is a suitable composition for forming a NMC oxide, more specifically Li(Ni_{1/3}Mn_{1/3}Co_{1/3})O₂. It is noted that the DES chemical precursor prepared with combinations of the four hydrated metal acetates was formed (on a molar basis) from 3 parts Li(CH₃COO); 1 part Mn(CH₃COO)₂; 1 part Co(CH₃COO)₂; and 1 part Ni(CH₃COO)₂.

### Example 2: Formation of Deep Eutectic Solvents (DES) Chemical Precursors with Metal Chloride and Nitrates

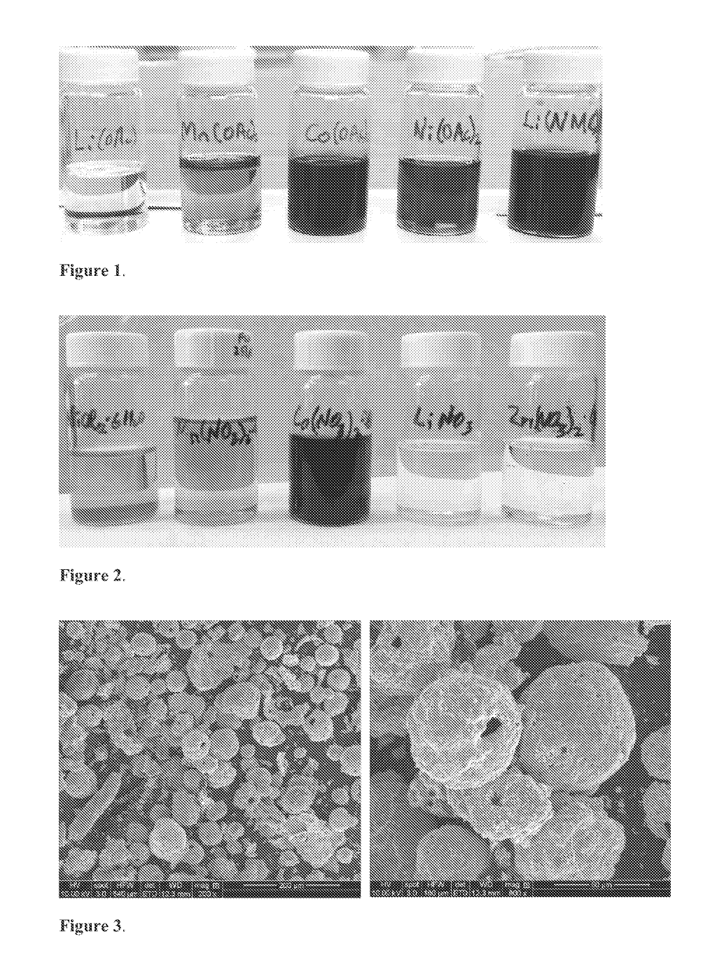

Samples of DES chemical precursors were also prepared using hydrated metal chloride, hydrated metal nitrates, and a metal nitrate. The hydrated metal chloride used was NiCl₂.6H₂O. The hydrated metal nitrates used were Mn(NO₃)₂.4H₂O; Co(NO₃)₂.4H₂O; and Zn(NO₃)₂.6H₂O. The metal nitrate used was LiNO₃. Glycerol was used as the hydrogen bond donor/complexing agent and solvent. The DES chemical precursors are shown in FIG. 2. The molar ratio of the salts to the hydrogen bond donor/complexing agent for each of the samples was 1:5.

### Example 3: NMC Oxide Powder Preparation Via Flame Spray Pyrolysis

The DES chemical precursor prepared in Example 1 from combinations of the hydrated metal acetates and glycerol was used in a flame spray pyrolysis process with an air atomizing nozzle to produce NMC oxide (Li(Ni_{1/3}Mn_{1/3}Co_{1/3})O₂) powder as follows. First, approximately 100 mL of the DES chemical precursor was heated to 100 degrees Celsius. Second, the DES chemical precursor was sprayed into a reaction chamber at a temperature of approximately 1,500 degrees Celsius where the NMC oxide (Li(Ni_{1/3}Mn_{1/3}Co_{1/3})O₂) powders were formed. Third, after burning, the metal oxide powders were collected downstream using a bag filter. The morphology of the NMC powder is shown in FIG. 3 in the electron microscopy images, each of which is at a different order of magnification.

### Example 4: NMC Oxide Powder Preparation Via Application of Microwaves

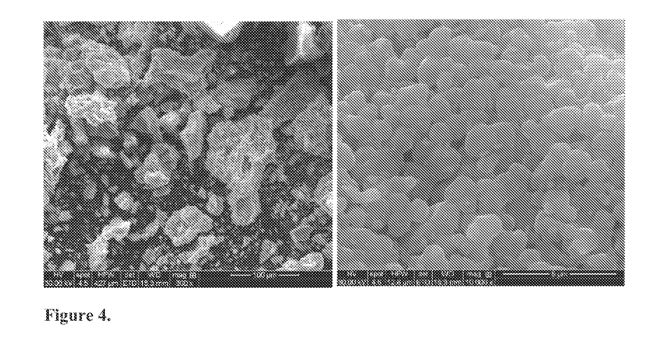

The DES chemical precursor prepared in Example 1 from combinations of the hydrated metal acetates and glycerol was used in a microwave process to produce NMC oxide (Li(Ni_{1/3}Mn_{1/3}Co_{1/3})O₂) powders as follows. The microwave used was a standard home microwave (800 W). First, 10 mL of the DES chemical precursor was placed in a beaker and placed in the microwave. Second, the DES chemical precursor was heated at full power for 10 minutes to form NMC oxide (Li(Ni_{1/3}Mn_{1/3}Co_{1/3})O₂) powder. The morphology of the NMC powder is shown in FIG. 4 in the electron microscopy images, each of which is at a different order of magnification.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying figures are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

I claim:

1. A process for forming a deep eutectic solvent chemical precursor containing one or more metal ions comprising the steps of:
providing one or more salts;
providing one or more hydrogen bond donors; and
combining said one or more salts with said one or more hydrogen bond donors.

2. The process of claim 1, wherein each of said one or more salts is selected from the group consisting of hydrated metal acetates, hydrated metal nitrates, hydrated metal sulfates, hydrated metal halides, metal acetates, metal nitrates, metal sulfates, metal halides, hydrated metal oxalates, metal oxalates, metal alkoxides, and combinations thereof.

3. The process of claim 1, wherein each of said hydrogen bond donors is selected from the group consisting of glycerol, ethylene glycol, acetamide, urea, and combinations thereof.

4. The process of claim 3, wherein said one or more hydrogen bond donors is glycerol.

5. The process of claim 2, wherein each of said one or more salts is selected from the group consisting of lithium acetate (Li(CH₃COO)), manganese acetate (Mn(CH₃COO)₂); cobalt acetate (Co(CH₃COO)₂); nickel acetate (Ni(CH₃COO)₂); Li(Ni_{1/3}Mn_{1/3}Co_{1/3})(CH₃COO)₂; Li(CH₃COO).2H₂O; Mn(CH₃COO)₂.4H₂O; Co(CH₃COO)₂.4H₂O; Ni(CH₃COO)₂.4H₂O; LiCl; MnCl₂; CoCl₂; NiCl₂; AlCl₃; LiClH₂O; MnCl₂.6H₂O; CoCl₂.6H₂O; NiCl₂.6H₂O; AlCl₃.9H₂O; Ni(NO₃)₂, Mn(NO₃)₂; Co(NO₃)₂; LiNO₃; Zn(NO₃)₂; Mn(NO₃)₂.4H₂O; Co(NO₃)₂.4H₂O; LiNO₃.xH₂O (x=0.5-3); Al(NO₃)₃.9H₂O; and combinations thereof.

6. The process of claim 4, wherein the molar ratio of said salt to said glycerol is between 1:1 and 1:10.

7. The process of claim 6, wherein the molar ratio of said salt to said glycerol is between 1:4 and 1:6.

8. The process of claim 7, wherein the molar ratio of said salt to said glycerol is 1:5.

9. The process of claim 1, wherein prior to said combining step, said one or more hydrogen bond donors are heated to reduce their viscosity.

10. The process of claim 9, wherein said one or more hydrogen bond donors are heated to reduce their viscosity by an order of magnitude.

11. The process of claim 9, wherein said combining step comprises constantly stirring said one or more hydrogen bond donors and gradually adding said one or more salts to said one or more hydrogen bond donors.

12. The process of claim 11, further comprising a heating step following said combining step wherein said one or more salts and said one or more hydrogen bond donors are heated to reduce their viscosity.

13. The process of claim 12, wherein following said combining step said one or more salts and said one or more hydrogen bond donors are heated to reduce their viscosity by an order of magnitude.

14. The process of claim 2, wherein said salt is a metal acetate formed by:
providing a metal carbonate;
providing acetic acid; and
reacting said metal carbonate with said acetic acid.

15. A process for forming one or more metal oxides comprising the steps of:
providing one or more deep eutectic solvents of claim 1; and
reacting said one or more deep eutectic solvents to produce said one or more metal oxides.

16. The process of claim 15, wherein said reaction step comprises flame spray pyrolysis to produce said one or more metal oxides.

17. The process of claim 16, wherein said flame spray pyrolysis is carried out at a temperature between 500 and 2000 degrees Celsius.

18. The process of claim 15, wherein said reaction step comprises microwaving said deep eutectic solvent to produce said one or more metal oxides.

19. The process of claim 15, wherein one or more deep eutectic solvents are provided during said providing step to produce at least one of said metal oxides that includes at least two different metals.

20. The process of claim 15, wherein said metal oxides are in powder form.

21. The process of claim 20, wherein said metal oxides are suitable for use in lithium-ion batteries.

22. The process of claim 15, wherein at least one of said metal oxides is selected from the group consisting of LiCoO₂, LiMn₂O₄, Li₁(NiMnCo)_{0.33}O₂, Li(Ni_{0.8}Co_{0.15}Al_{0.05})O₂, and combinations thereof.

23. The process of claim 15, wherein at least one of said metal oxides is selected from the group consisting of lithium oxide, cobalt oxide, manganese oxide, nickel oxide, and combinations thereof.

24. The process of claim 15, wherein said reacting step further comprises producing carbon dioxide and water.
